(19) United States
(12) Patent Application Publication
(10) Pub. No.: US 2020/0095004 A1
(43) Pub. Date: Mar. 26, 2020

(54) LABELLING APPARATUS

(71) Applicant: Edward P. Hofrichter, Vista, CA (US)

(72) Inventor: Edward P. Hofrichter, Vista, CA (US)

(21) Appl. No.: 16/138,862

(22) Filed: Sep. 21, 2018

(51) Int. Cl. B65C 9/40; B65C 9/18

(52) U.S. Cl. CPC B65C 9/40; B65C 9/1869

(57) ABSTRACT

The labelling apparatus includes a first motor configured to drive movement of one or more tags of a plurality of tags from a first tray holding the plurality of tags to an intersection point and a second motor configure to drive movement of a sheet from a second tray to the intersection point and about an edge at the intersection point. The sheet includes a plurality of labels positioned on a backing. Movement of the sheet about the edge causes one or more labels to peel from the backing at the intersection point. The first motor and the second motor are configured to drive movement of the one or more tags and the sheet so that the one or more tags engage the one or more labels peeled from the backing at the intersection point.

### BACKGROUND

### Field

This invention relates to labels, and more particularly, relates to apparatuses for affixing labels to tags.

### Description of the Related Art

Hangtags are commonly attached to items sold at stores. Hangtags can be affixed with labels that provide informational text. Such labels can include barcodes or other information about the item, such as a price or size. Traditionally, after the labels are printed, the labels are manually affixed to the hangtags.

### SUMMARY

In a first aspect, a high-speed labelling apparatus, comprises a first tray configured to support a plurality of tags arranged in at least one stack; a second tray disposed above the first tray and configured to support a sheet of a plurality of labels positioned on a backing; a plurality of rollers configured to draw tags one at a time from a bottom of one stack of the at least one stack and transport the drawn tags to the intersection point, the intersection point having an edge; a first motor configured to drive the plurality of rollers; and a second motor configure to drive movement of the sheet to the intersection point and about the edge of the intersection point so as to cause one or more labels of the plurality of labels to peel from the backing at the intersection point. The first motor and the second motor are configured to control movement of the drawn tags and the sheet so that each of the drawn tags one at a time engages a label of the one or more labels peeled from the backing at the intersection point.

In another aspect, a labelling apparatus comprises a first motor configured to drive movement of one or more tags of a plurality of tags from a first tray holding the plurality of tags to an intersection point; and a second motor configure to drive movement of a sheet from a second tray to the intersection point and about an edge at the intersection point, the sheet comprising a plurality of labels positioned on a backing, wherein movement of the sheet about the edge causes one or more labels to peel from the backing at the intersection point. The first motor and the second motor are configured to drive movement of the one or more tags and the sheet so that the one or more tags engage the one or more labels peeled from the backing at the intersection point.

In another aspect, a method for attaching a label of a plurality of labels to a tag of a plurality of tags comprises controlling a first motor to drive a sheet comprising a backing and the plurality of labels towards an intersection point; determining that the label is positioned at the intersection point based on information from a first sensor; deactivating the first motor to stop movement of the label at the intersection point based on the determination that the label is positioned at the intersection; and controlling a second motor to transport the tag to the intersection point to engage the label based on information from a second sensor.

### BRIEF DESCRIPTION OF THE DRAWINGS

The features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will now be described with additional specificity and detail through use of the accompanying drawings.

FIG. 1 is a front perspective view of a labelling apparatus according to a preferred embodiment of the present invention.

FIG. 2 is a second front perspective view of the labeling apparatus of FIG. 1.

FIG. 3 is a rear perspective of the labelling apparatus of FIG. 1.

FIG. 4 is a front view of the labelling apparatus of FIG. 1.

FIG. 5 is a top view of the labelling apparatus of FIG. 1.

FIG. 5A is a cross-sectional view of the labelling apparatus of FIG. 1 taken along line 5A-5A as shown in FIG. 5.

FIG. 6 is a side view of the labelling apparatus of FIG. 1.

FIG. 7 is a side view of the labelling apparatus of FIG. 1.

FIG. 8 is a perspective view of a lower assembly of the labelling apparatus of FIG. 1.

FIG. 9 is a top view of the lower assembly of FIG. 8.

FIG. 10 is a cross-sectional view of the lower assembly of FIG. 8 taken along line 10-10 as shown in FIG. 9.

FIG. 11 is a rear view of the lower assembly of FIG. 8.

FIG. 12 is a front view of the lower assembly of FIG. 8.

FIG. 13 is a cross-sectional view of the lower assembly of FIG. 8 taken along line 13-13 as shown in FIG. 12.

FIG. 14 is side view of the lower assembly of FIG. 8.

FIG. 15 is a side view of the lower assembly of FIG. 8.

FIG. 16 is a perspective view of an upper assembly of the labelling apparatus of FIG. 1.

FIG. 17 is a front view of the upper assembly of FIG. 16 depicting a plurality of labels positioned thereon.

FIG. 17A is a cross-sectional view of the labelling apparatus of FIG. 1 taken along line 5A-5A as shown in FIG. 5 depicting a plurality of labels positioned thereon.

FIG. 17B is a sectional view of the labelling apparatus of FIG. 1 taken along line 17B-17B as shown in FIG. 17A.

FIG. 18 is a perspective view of a label tray of the labelling apparatus of FIG. 1.

FIG. 19 is a perspective view of the label tray of FIG. 18.

FIG. 20 is a block diagram depicting electrical components of the labelling apparatus of FIG. 1.

### DETAILED DESCRIPTION

The following detailed description is directed to certain specific embodiments. The invention(s) disclosed herein, however, can be embodied in a multitude of different ways as defined and covered by the claims. In this description, reference is made to the drawings, wherein like parts are designated with like numerals throughout. The features, aspects and advantages of the present invention will now be described with reference to the drawings of several embodiments that are intended to be within the scope of the development herein disclosed. These and other embodiments will become readily apparent to those skilled in the art from the following detailed description of the embodiments having reference to the attached figures, the invention not being limited to any particular embodiment(s) herein disclosed.

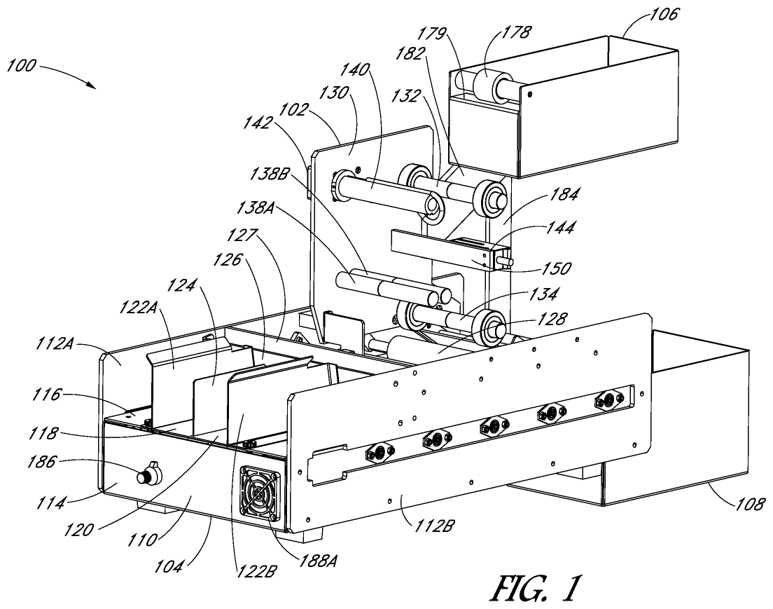

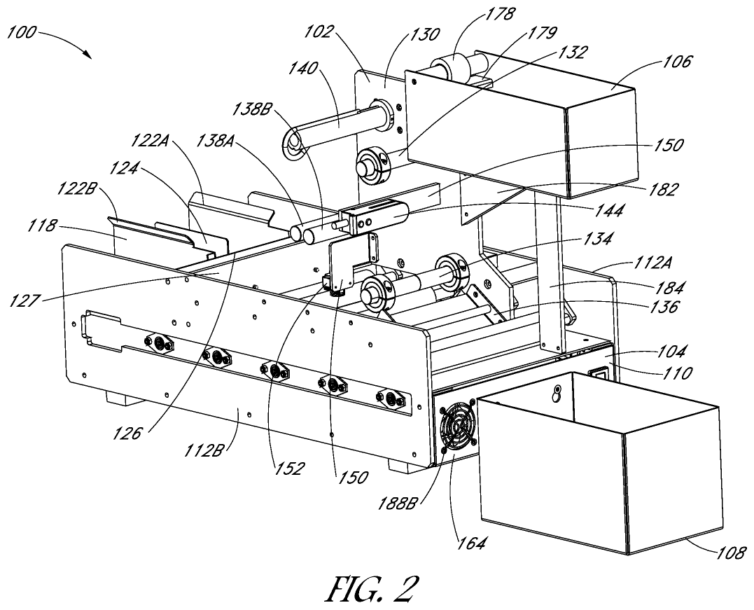

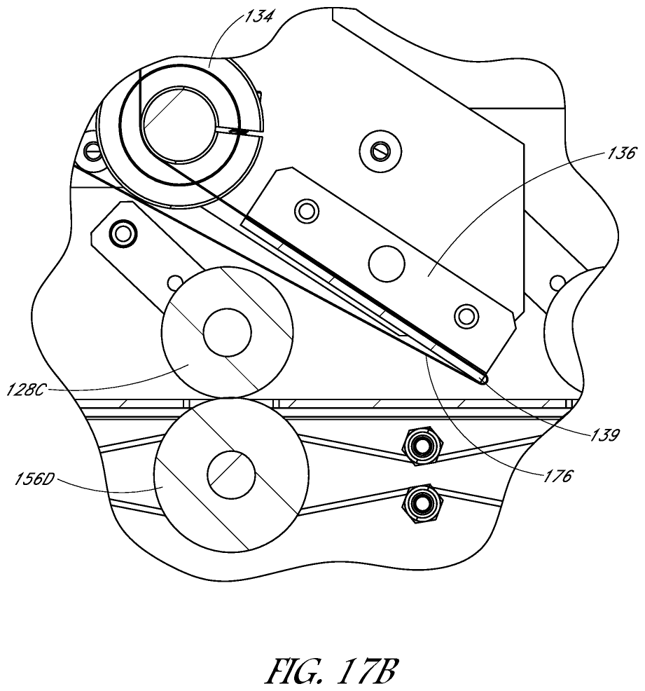

FIGS. 1 and 2 illustrate perspective views of an embodiment of a labeling apparatus 100 for applying labels to tags. In certain embodiments, the labeling apparatus 100 can be configured to transport one or more tags and one or more labels to an intersection point (shown in FIG. 17B), at which the labels can be applied to the tags.

In certain embodiments, the apparatus 100 can include an upper assembly 102. The upper assembly 102 can be configured to transport one or more labels to the intersection point at which the labels can be received by the one or more hang tags.

In certain embodiments, the upper assembly 102 includes an upper shaft 132. The upper shaft 132 can be sized, shaped, positioned, or otherwise configured to receive one or more labels from a source of labels. In certain embodiments, the one or more labels can be positioned on a backing paper. In certain embodiments, the one or more labels may be releasably secured to the backing paper by an adhesive on one side of each label. In certain embodiments, the labels and backing paper can together form a roll or sheet of labels. In certain embodiments, the upper shaft 132 can be sized, shaped, positioned, or otherwise configured to receive a roll or sheet of labels from a source of labels. In certain embodiments, the upper shaft 132 can be configured to receive one or more labels from a label tray 106. In certain embodiments, the upper shaft 132 can be configured to receive a roll of labels or a sheet of labels from the label tray 106. In certain embodiments, the upper shaft 132 can act as a guide to a roll or sheet of labels as the labels attached to the roll or sheet of labels are transported to the intersection point. In certain embodiments, the roll or sheet of labels can extend around or wrap around a portion of the upper shaft 132.

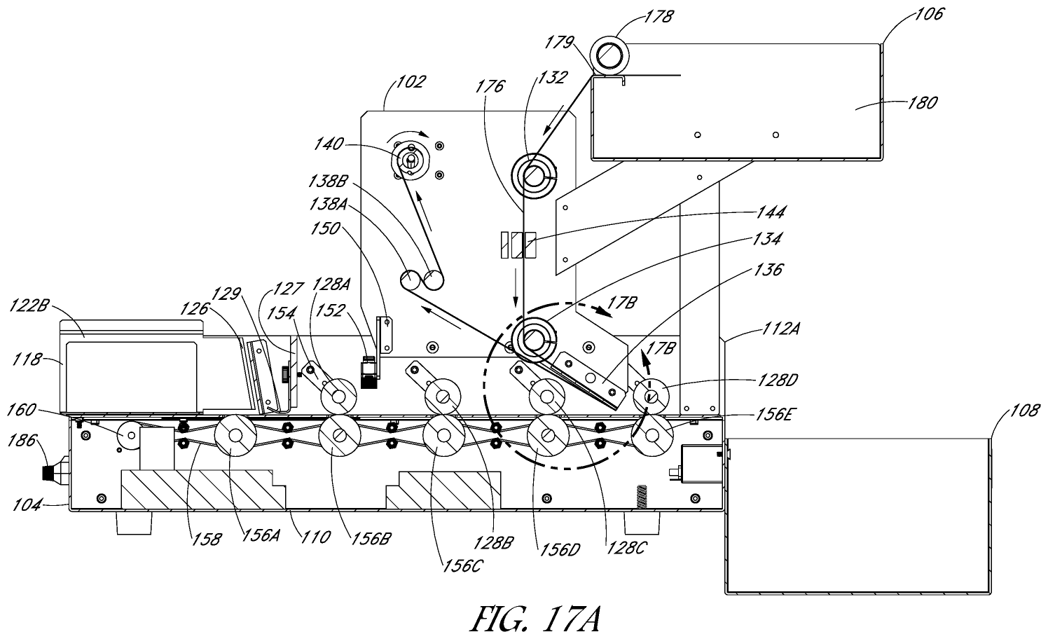

In certain embodiments, one or more collars 172A-B (see FIG. 16) can be positioned on the upper shaft 132. In certain embodiments, the collars 172A-B be positioned to allow a roll or sheet of labels to extend between the collars 172A-B. In certain embodiments, the collars 172A-B can be positioned to provide lateral alignment of the roll or sheet of labels about the upper shaft 132.

In certain embodiments, the upper assembly 102 can include a lower shaft 134. The lower shaft 134 can be sized, shaped, positioned, or otherwise configured to receive one or more labels as the one or more labels are transported from the source of labels to the intersection point. In certain embodiments, the lower shaft 134 can be sized, shaped, positioned, or otherwise configured to receive a roll or sheet of labels as the labels attached to the sheet are transported from the source of labels to the intersection point. In certain embodiments, the lower shaft 134 can be sized, shaped, positioned, or otherwise configured to receive one or more labels from the upper shaft 132. In certain embodiments, the lower shaft 134 can be sized, shaped, positioned, or otherwise configured to receive a roll or sheet of labels from the upper shaft 132. In certain embodiments, the lower shaft 134 can act as a guide to a roll or sheet of labels as the labels attached to the roll or sheet of labels are transported to the intersection point. In certain embodiments, the roll or sheet of labels can extend around or wrap around a portion of the lower shaft 134.

In certain embodiments, one or more collars 172C-D (see FIG. 16) can be positioned on the lower shaft 134. In certain embodiments, the collars 172C-D can be positioned to allow a roll or sheet of labels to extend between the collars 172C-D. In certain embodiments, the collars 172C-D can be positioned to provide lateral alignment of the roll or sheet of labels about the lower shaft 134.

In certain embodiments, the upper assembly 102 can include a bracket or plate 136 (see FIG. 2). In certain embodiments, the plate 136 can be sized, shaped, positioned, or otherwise configured to receive one or more labels as the one or more labels are transported from the source of labels to the intersection point. In certain embodiments, the plate 136 can be sized, shaped, positioned, or otherwise configured to receive a roll or sheet of labels as the labels attached to the sheet are transported from the source of labels to the intersection point. In certain embodiments, the plate 136 can be sized, shaped, positioned, or otherwise configured to receive one or more labels from the lower shaft 134. In certain embodiments, the plate 136 can be sized, shaped, positioned, or otherwise configured to receive a roll or sheet of labels from the lower shaft 134. In certain embodiments, the plate 136 can act as a guide to a roll or sheet of labels as the labels attached to the roll or sheet of labels are transported to the intersection point. In certain embodiments, the roll or sheet of labels can be traversed about an edge of the plate 136 such that one or more labels traversing over the edge of the plate 136 peel away from the backing of the roll or sheet of labels. In certain embodiments, the one or more labels traversing over the edge of the plate 136 can peel away from the backing of the roll or sheet of labels due to an angle at which the roll or sheet traverses around the edge of the plate 136.

In certain embodiments the upper assembly 102 can include a pair of rollers 138A-B (see FIG. 1). In certain embodiments, the rollers 138A-B can be sized, shaped, positioned, or otherwise configured to receive a backing from the roll or sheet of labels after the labels are removed from the backing. In certain embodiments, the rollers 138A-B can be sized, shaped, positioned, or otherwise configured to receive a backing from the roll or sheet of labels from the plate 136. In certain embodiments, the backing can extend around or wrap around the rollers 138A-B. In certain embodiments, the rollers 138A-B can provide tension to the roll or sheet of labels as the roll or sheet of labels progresses through the upper assembly 102. In certain embodiments, the rollers 138A-B can be positioned so that the backing of the roll or sheet of labels extends between the plate 136 and the rollers 138A-B about an angle that causes the labels traversing over the edge of the plate 136 to peel away from the backing of the roll or sheet of labels.

In certain embodiments, the upper assembly 102 can include a reel or spool 140. In certain embodiments, the upper assembly 102 can include a pin 170 (see FIG. 16). In certain embodiments, the pin 170 can be a cotter pin, a split pin, or an R-clip. In certain embodiments, the spool 140 can be sized, shaped, positioned, and/or otherwise configured to receive a backing of the roll or sheet of labels after the labels are removed from the backing. In certain embodiments, the spool 140 can be sized, shaped, positioned, and/or otherwise configured to receive a backing of the roll or sheet of labels from the rollers 138A-B. In certain embodiments, the spool 140 can rotate about an axis to cause the backing from the roll or sheet of labels to wind around the spool 140. In certain embodiments, the spool 140 can rotate about an axis to cause the backing from the roll or sheet of labels to wind around the spool 140 to cause the roll or sheet of labels to move throughout the upper assembly 102. For example, in certain embodiments, the winding of the backing around the spool 140 can cause portions of the backing to move from the rollers 138A-B to the spool 140, from the bracket 136 to the rollers 138A-B, from the lower shaft 134 to the bracket 136, from the upper shaft 132 to the lower shaft 134, and/or from the label tray 106 to the upper shaft 132.

In certain embodiments, the upper assembly 102 can include a sensor 144. In certain embodiments, the sensor 144 can be an optical sensor. In certain embodiments, the sensor 144 can be a gap sensor or a slot sensor. In certain embodiments, the sensor 144 can be configured to detect the presence of one or more labels positioned on a roll or sheet of labels. In certain embodiments, the sensor 144 can be configured to detect the absence of one or more labels positioned on a roll or sheet of labels. In certain embodiments, the sensor 144 can be configured to detect a position of one or more labels on the roll or sheet of labels. In certain embodiments, the sensor 144 can be configured to detect a position of one or more labels on the roll or sheet of labels relative to other labels on the roll or sheet of labels. In certain embodiments, the sensor 144 can be configured to detect movement of labels throughout the upper assembly 102. In certain embodiments, the sensor 144 can be positioned to detect movement of the roll or sheet of labels throughout the upper assembly 102. In certain embodiments, the sensor 144 can be configured to detect a gap between labels positioned on the roll or sheet of labels.

As shown in FIG. 2, the sensor 144 can be positioned between the upper shaft 132 and the lower shaft 134. In certain embodiments, the sensor 144 can be configured to detect labels or a portion of the roll or sheet of labels positioned between the upper shaft 132 and the lower shaft 134. In certain embodiments, the sensor 144 can be positioned between the lower shaft 134 and the plate 136. In certain embodiments, the sensor 144 can be configured to detect labels or a portion of the roll or sheet of labels positioned between the lower shaft 134 and the plate 136. In certain embodiments, the sensor 144 can be positioned between the plate 136 and the rollers 138A-B. In certain embodiments, the sensor 144 can be configured to detect a portion of the roll or sheet of labels positioned between the plate 136 and the rollers 138A-B. In certain embodiments, the sensor 144 can be positioned between the rollers 138A-B and the spool 140. In certain embodiments, the sensor 144 can be configured detect a portion of the roll or sheet of labels positioned between the rollers 138A-B and the spool 140.

In certain embodiments, the upper assembly 102 can include a motor 142. The motor 142 can be configured to drive movement of the one or more labels from the label source to the intersection point. In certain embodiments, the motor 142 can be configured to drive movement of the roll or sheet of labels about the upper assembly 102. In certain embodiments, the motor 142 can be coupled to the spool 140. In certain embodiments, the motor 142 can be configured do drive rotation of the spool 140. In certain embodiments, the motor 142 can be configured to drive rotation of the spool 140 to cause the roll or sheet of labels to wind around the spool 140 to cause the roll or sheet of labels to move throughout the upper assembly 102. The motor 142 can be activated to cause movement of the one or more labels throughout the upper assembly 102 and deactivated to stop movement of the labels. In certain embodiments, the motor 142 can be configured to drive movement of the one or more labels throughout the upper assembly 102 based at least in part on information from the sensor 144.

In certain embodiments, the upper assembly 102 can include a sidewall 130. In certain embodiments, one or more components of the upper assembly 102 can be secured to the sidewall 130. In certain embodiments, the upper shaft 132 can be secured to the sidewall. In certain embodiments, the lower shaft 134 can be secured to the sidewall 130. In certain embodiments, the plate 136 can be secured to the sidewall 130. In certain embodiments, the rollers 138A-B can be secured to the sidewall 130. In certain embodiments, the spool 140 can be secured to the sidewall 130. In certain embodiments, the motor 142 can be secured to the sidewall 130. In certain embodiments, the sensor 144 can be secured to the sidewall 130. In certain embodiments, the sensor 144 can be secured to the sidewall 130 by an arm 150.

As described herein, in certain embodiments, the labelling apparatus 100 can include the label tray 106. The label tray 106 can receive and/or house a plurality of labels for use in the labelling apparatus 100. In certain embodiments, the label tray 106 can be sized, shaped, and/or otherwise configured to receive and/or house a roll or sheet of labels. In certain embodiments, the label tray 106 can be sized, shaped, and/or otherwise configured to receive and/or hold a plurality of rolls or sheets of labels. In certain embodiments, the label tray 106 can house one or more labels for supply to the upper assembly 102 for transport to the intersection point. In certain embodiments the label tray 106 can house one or more rolls or sheets of labels for supply to the upper assembly 102 for transport to the intersection point. In certain embodiments, the label tray 106 can be secured to the sidewall 130 of the upper assembly 102 by a plate 182.

In certain embodiments, the labelling apparatus 100 can include a lower assembly 104. In certain embodiments, the lower assembly 104 can be configured to transport one or more tags to the intersection point. In certain embodiments, the lower assembly 104 can be configured to transport one or more tags between a first end or proximal end 114 of the lower assembly 104 to a second end or distal end 164 of the lower assembly 104. At the intersection point, the one or more tags can receive a label from the upper assembly 102.

In certain embodiments, the lower assembly 104 can include a base 110. The base 110 can house one or more components for transporting one or more tags to the intersection point. In certain embodiments, the base 110 can include a top plate or cover 116. In certain embodiments, the label tray 106 can be secured to the cover 116 by a plate 184.

In certain embodiments, the lower assembly 104 can include a tray 118. In certain embodiments, the tray 118 can be configured to house one or more tags prior to transport of the tags to the intersection point. In certain embodiments, the tray 118 can be configured to align the tags in a position or configuration for transporting the tags to the intersection point. In certain embodiments, the tray 118 can be configured to house a vertical stack of tags. In certain embodiments, the tray 118 can be configured to house a plurality of tags positioned in a lateral row of tags. For example, the tray 118 may be configured to house two tags positioned laterally next to one another. In certain embodiments, the tray 118 can house three, four, five, six, or any other number of tags laterally next to one another.

In certain embodiments, the tray 118 can be mounted to the top cover 116 of the base 110. In certain embodiments, the tray 118 can include one or more sidewalls 122A-B. In certain embodiments, the sidewalls 122A-B can extend superiorly from a bottom surface 120 of the tray 118. In certain embodiments, the sidewalls 122A-B can be sized, positioned, shaped, or otherwise configured to align one or more tags within the tray 118.

In certain embodiments, the tray 118 can include one or more dividers 124. In certain embodiments, the dividers 124 can be sized, positioned, shaped, or otherwise configured to align one or more tags within the tray 118.

In certain embodiments, the lower assembly 104 can include a divider 126. The divider 126 can be positioned between the tray 118 and the intersection point. In certain embodiments, the divider 126 can form a front barrier for tags positioned within the tray 118. In certain embodiments, the divider 126 can prevent at least some tags of a plurality of tags positioned within the tray from moving towards the second end 164 of the lower assembly 104.

In certain embodiments, the dividers 124, the divider 126, and/or the sidewalls 122A-B can separate the tray 118 into a plurality of slots, chambers, or tray sections for holding one or more tags. In certain embodiments, the tray 118 can be mounted on a top cover 116 of the base 110. In certain embodiments, the lower assembly 104 can include one or more components configured to transport or feed the one or more tags from the tray 118 to the intersection point.

As shown in FIG. 2, in certain embodiments, the lower assembly 104 can include a sidewall 112A and a sidewall 112B. In certain embodiments, one or both of the sidewall 112A and the sidewall 112B can extend superiorly from the base 110. In certain embodiments, one or more rollers 128 can be coupled to one or both of the sidewall 112A and the sidewall 112B. In certain embodiments, the rollers 128 can extend between the sidewall 112A and the sidewall 112B. In certain embodiments, the rollers 128 can be positioned to facilitate transport of the one or more tags towards the intersection point.

In certain embodiments, the labelling apparatus can include a labeled tag tray 108. The labeled tag tray 108 can be positioned to receive labeled tags from the lower assembly 104 after labels are affixed to the tags at the intersection point. In certain embodiments, the labeled tag tray 108 is positioned adjacent to the second end 164 of the lower assembly 104. In certain embodiments, the labeled tag tray 108 is secured to the second end 164 of the lower assembly 104.

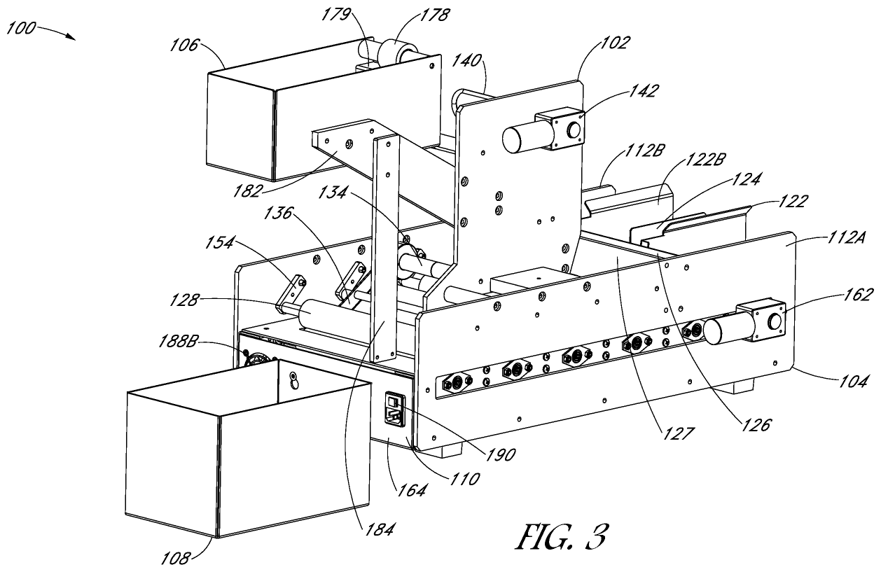

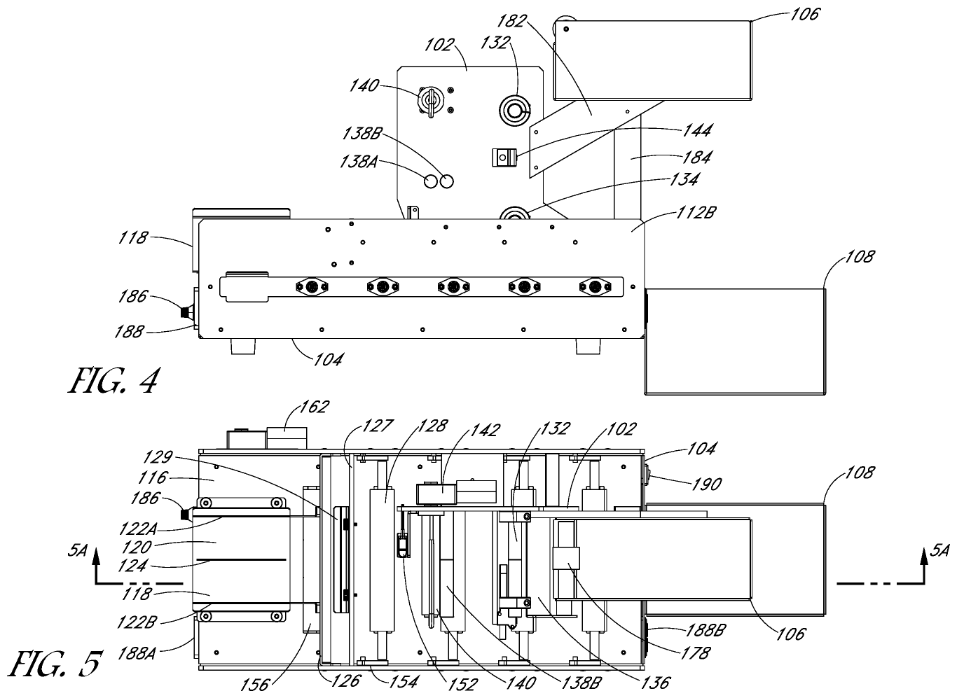

FIG. 3 illustrates a rear perspective view of the labeling apparatus 100. FIG. 4 illustrates a front view of the labelling apparatus 100. FIG. 5 illustrates a top view of the labelling apparatus 100. FIG. 5A illustrates a cross-sectional view of the labelling apparatus 100 taken along line 5A-5A in FIG. 5.

As shown in FIG. 5A, the lower assembly 104 can include a plurality of rollers 156A-E. The plurality of rollers 156A-E can be driven by a timing belt 158. In certain embodiments, the timing belt 158 can be driven by one or more motors 162. In certain embodiments, the timing belt 158 can be driven by the motor 162 via a pulley 160. In certain embodiments, the plurality of rollers 156A-E can draw the tags from the tray 118 towards the intersection point.

In certain embodiments, each roller 156A-E can be configured to rotate such that a tag contacting the roller 156A-E will be drawn in a direction from the first end of the lower assembly 104 towards the second end of the lower assembly 104. In certain embodiments, the rollers 156A-E can be positioned within the base 110. In certain embodiments, the cover 116 of the base 110 can include a plurality of slots or openings through which at least portions each roller 156A-E can protrude to engage the tags.

As shown in FIG. 5A, in certain embodiments, the divider 126 can be angled or curved proximally from a bottom edge of the divider 126 to a top edge of the divider 126. As described herein the divider 126 can act as a barrier preventing distal movement of at least some tags within the tray 118. In certain embodiments, tags housed within the tray 118 can be received within the tray 118 so that the tags abut the divider 126. The angled shape of the divider 126 can align the tags in a stepped configuration within the tray 118. For example, the angled shape of the divider 126 can align a stack of tags within the tray 118 such that a proximal end of each tag in the stack is positioned proximally from a proximal end of any tag positioned lower in the stack.

In certain embodiments, the divider 126 can be positioned between a first roller 156A of the one or more rollers 156A-E and a second roller 156B of the one or more rollers 156A-E. In certain embodiments, the first roller 156A can be positioned to draw tags from the tray 118 and move the tags distally below a bottom surface of the divider 126. In certain embodiments, a height of the divider 126 can be adjustable. The divider 126 can be moved up or down to accommodate tags of different thicknesses. In certain embodiments, the height of the divider 126 can be adjusted to limit the number of tags drawn beneath the divider 126. For example, the height of the divider 126 can be adjusted so that only a single tag or a single horizontal layer of tags positioned laterally to one another can be drawn beneath the divider 126.

In certain embodiments, the lower assembly 104 can include a plate 129. The plate 129 can be adjustably mounted to a support 127. In certain embodiments, the plate 129 can be positioned distally from the divider 126. In certain embodiments, a height of the plate 129 can be adjustable. In certain embodiments, the height of the plate 129 can be adjusted to limit the number of tags allowed to pass through the feeder. For example, the height of the plate 129 can be adjusted so that only a single tag or a single horizontal layer of tags positioned laterally to one another can pass one at a time through the feeder and under the plate 129. In certain embodiments, the plate 129 and the divider 126 together prevent a stack of tags from passing through the feeder. In this way, the tags are held in place so only one tag feeds through the feeder at a time. In certain embodiments, the plate 129 can be moved up or down to accommodate tags of different thicknesses. In certain embodiments, the plate 129 can be shaped, sized, positioned, or otherwise configured to prevent upwards movement of a tag moving distally below the plate 129 and/or hold tags in place so only one tag is fed through the feeder at a time. In certain embodiments, the plate 129 can be shaped, sized, positioned, or otherwise configured to direct a tag moving distally below the plate 129 towards the roller 156B.

In certain embodiments, the one or more rollers 128 can include rollers 128A-D. In certain embodiments, one or more of the rollers 128A-D can be aligned above one or more of the rollers 156B-E. In certain embodiments, the roller 128A can positioned above the roller 156B and in alignment with the roller 156B. In certain embodiments, the roller 128B can positioned above the roller 156C and in alignment with the roller 156C. In certain embodiments, the roller 128C can positioned above the roller 156D and in alignment with the roller 156D. In certain embodiments, the roller 128D can positioned above the roller 156E in alignment with the roller 156E.

In certain embodiments, the rollers 128A-D are not connected to a motor. In certain embodiments, the rollers 128A-D are free turning. In certain embodiments, the rollers 128A-D are configured to roll across a top surface of the tags as the tags are moved by contact with the driven lower rollers 156A-E. In certain embodiments, the upper rollers 128A-D are suspending by arms 154. The arms 154 can be adjustable. In certain embodiments, the arms 154 can be adjusted to move the rollers 128A-D up or down. In certain embodiments, the arms 154 can be moved up or down to accommodate hangtags of different thicknesses.

In certain embodiments, the plate 129 can be sized, shaped, positioned, or otherwise configured to direct a label moving distally beneath the plate 129 to be drawn between the roller 128A and the roller 156B. In certain embodiments, the roller 156B can rotate to draw a label engaging the roller 156B between the roller 128A and the roller 156B and distally towards the roller 156C. In certain embodiments, the roller 156C can rotate to draw a label engaging the roller 156C between the roller 128B and the roller 156C and distally towards the roller 156D. In certain embodiments, the roller 156D can rotate to draw a label engaging the roller 156D between the roller 128C and the roller 156D and distally towards the roller 156E. In certain embodiments, the roller 156E can rotate to draw a label engaging the roller 156E between the roller 128D and the roller 156E and distally towards the second end 164 of the lower assembly 104.

In certain embodiments, a distal edge of the plate 136 can be positioned horizontally between the rollers 156D and 156E. The distal edge of the plate 136 can be positioned vertically relative to the lower assembly 104 such that a tag moving distally between the rollers 156D and 156E will engage a label peeled away from the backing of the roll or sheet of labels as the roll or sheet of labels traverse about the distal edge of the plate 136.

In certain embodiments, the labelling apparatus 100 can include a sensor 152. In certain embodiments, the sensor 152 can be part of the upper assembly 102. In certain embodiments, the sensor 152 can be mounted to the sidewall 130 of the upper assembly 102. As shown in FIG. 5A, in certain embodiments, the sensor 152 can be positioned horizontally between the roller 156B and the roller 156C. In certain embodiments, the sensor 152 can be positioned horizontally between the roller 156A and the roller 156B. In certain embodiments, the sensor 152 can be positioned horizontally between the roller 156C and the roller 156D. In certain embodiments, the sensor 152 can be positioned horizontally between the roller 156D and the roller 156E.

In certain embodiments, the sensor 152 can be configured to detect the presence of a tag beneath the sensor 152. In certain embodiments, the sensor 152 can be configured to detect the absence of a tag near the sensor 152. In certain embodiments, the sensor 152 can be configured to detect a position of a tag near the sensor 152. In certain embodiments, the sensor 152 can be configured to detect movement of a tag near the sensor 152.

In certain embodiments, the sensor 152 can be an optical sensor. In certain embodiments, the sensor 152 can be a photoelectric sensor. In certain embodiments, the motor 162 can be used to drive the rollers 156A-E based at least in part on information from the sensor 152.

In certain embodiments, the lower assembly 104 can include a user interface 186 configured to control operation of the labelling apparatus 100. In certain embodiments, the user interface 186 can be manipulated to control operation of one or both of the motor 142 and the motor 162. The user interface 186 can be a knob, button, touchscreen, or any other suitable user interface.

In certain embodiments, the lower assembly 104 can include one or more fans 188A-B for cooling of the lower assembly 104. In certain embodiments, the lower assembly 104 can include a pair of fans 188A-B. In certain embodiments, the lower assembly 104 can include a port 190 for receiving a power cable.

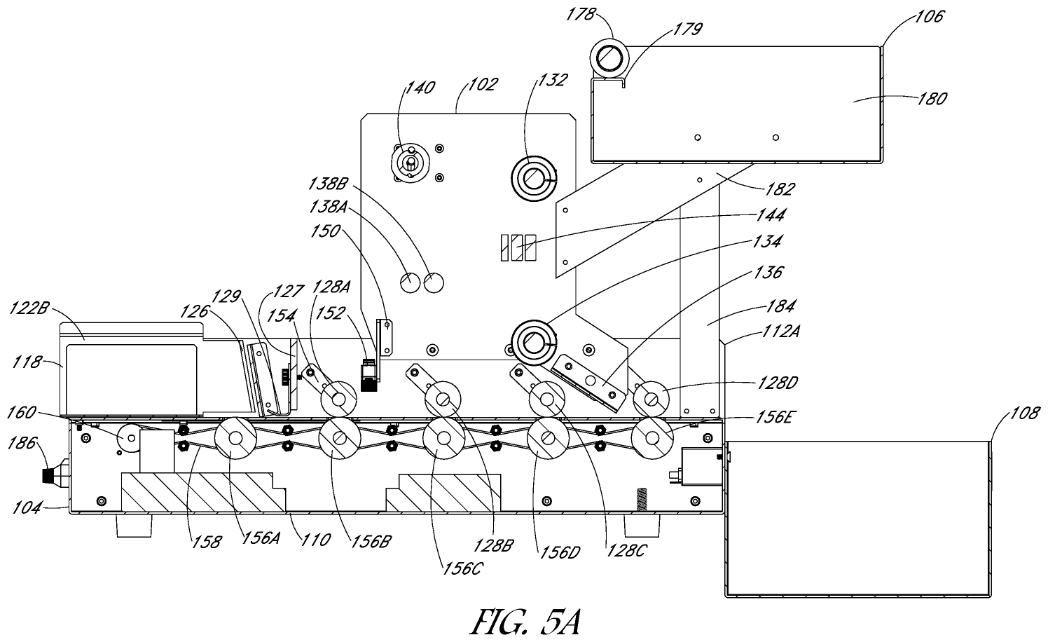

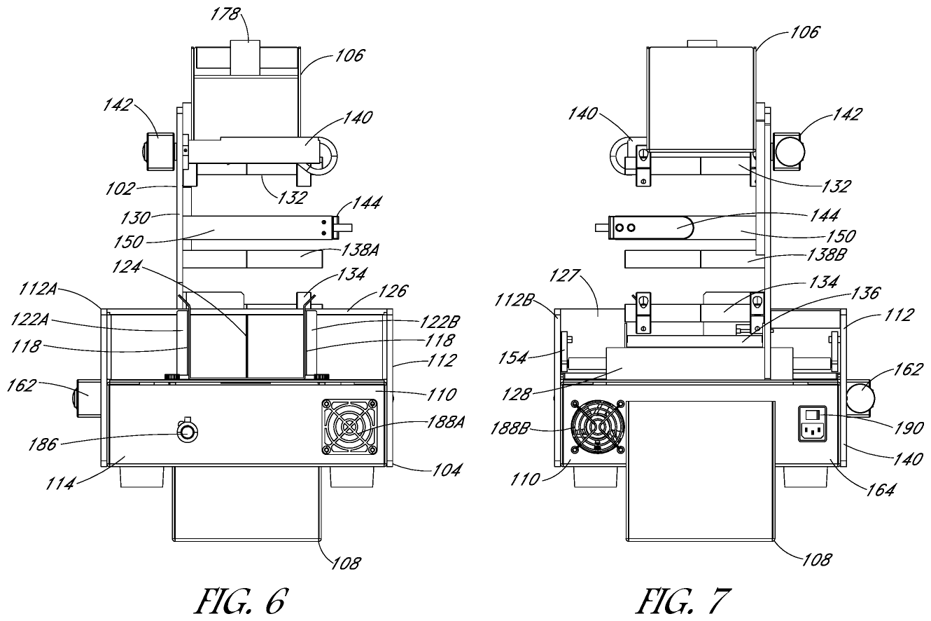

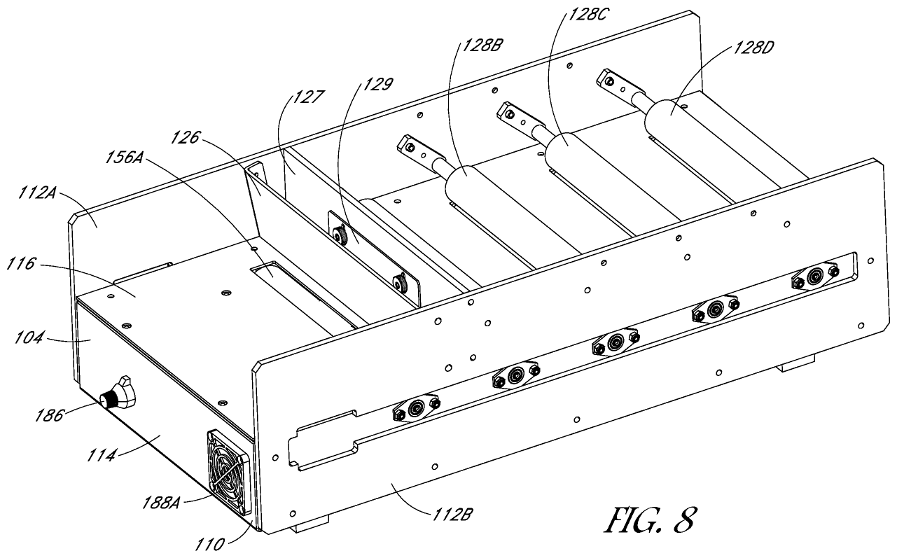

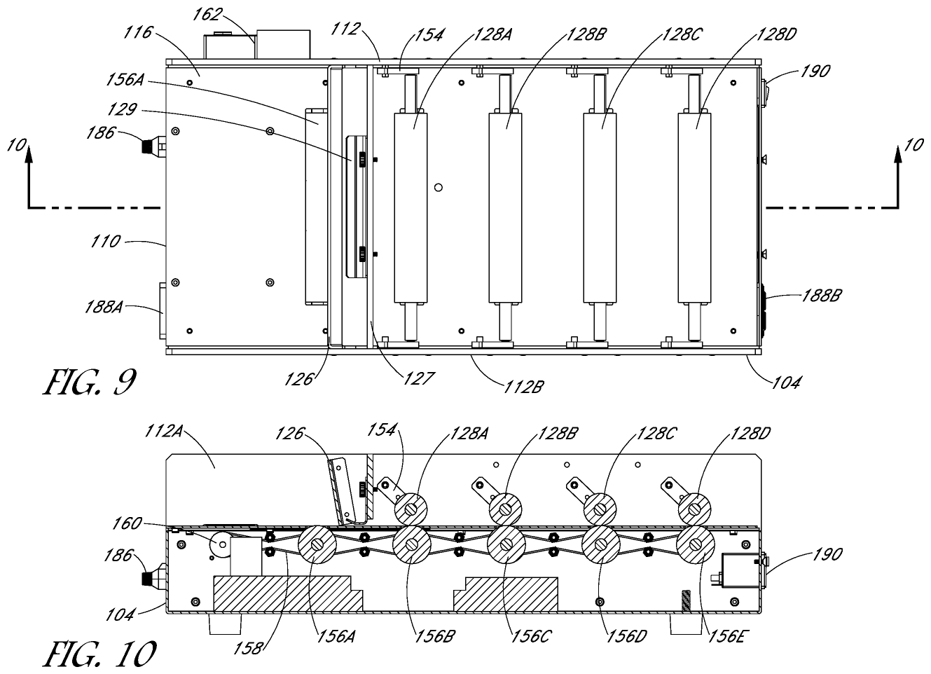

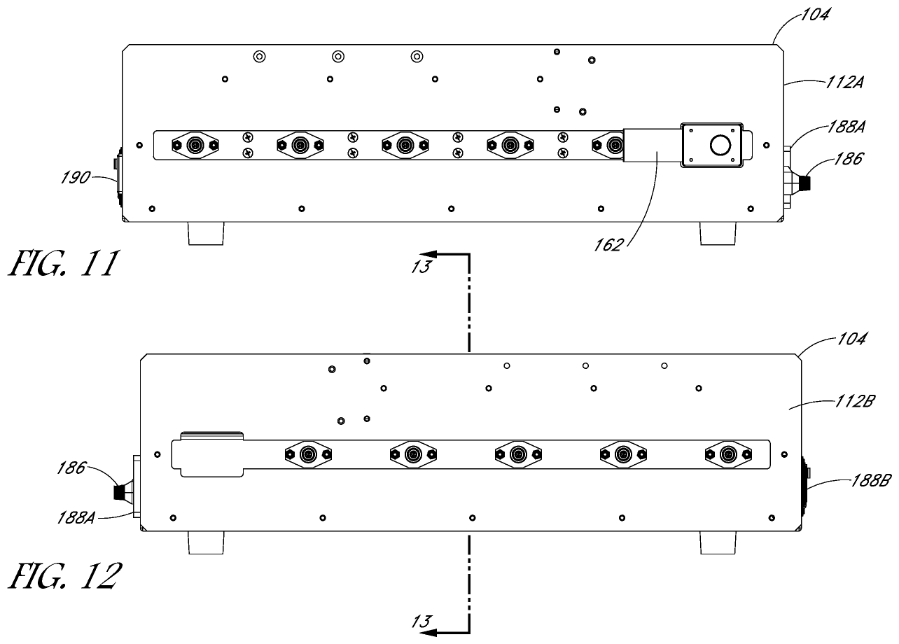

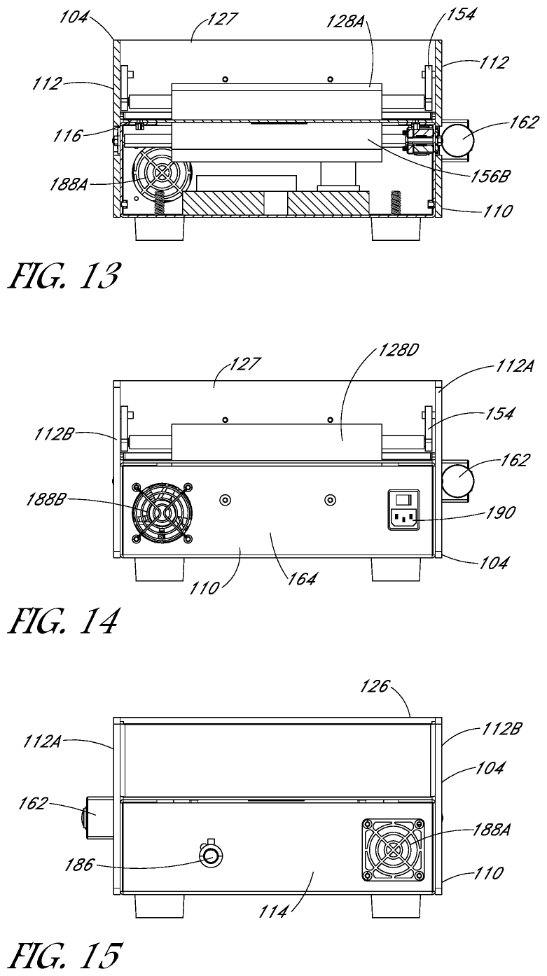

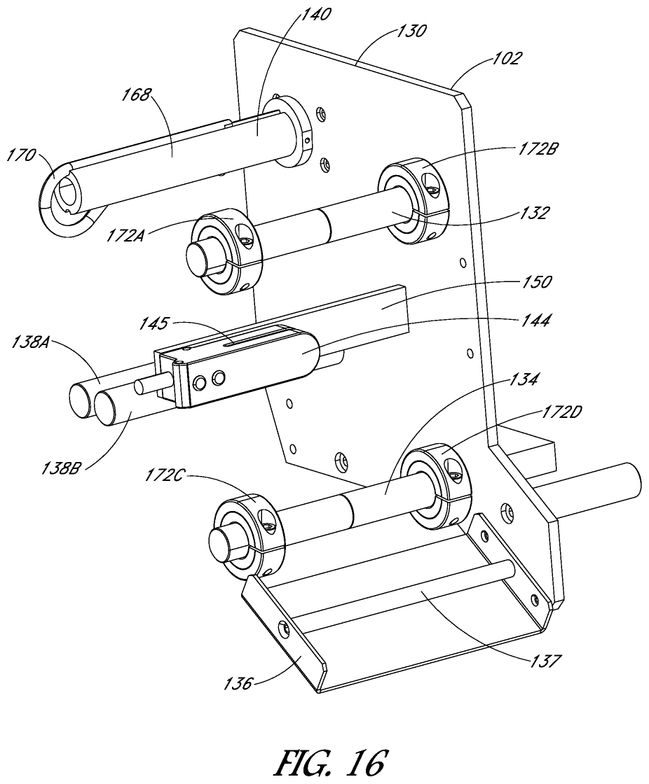

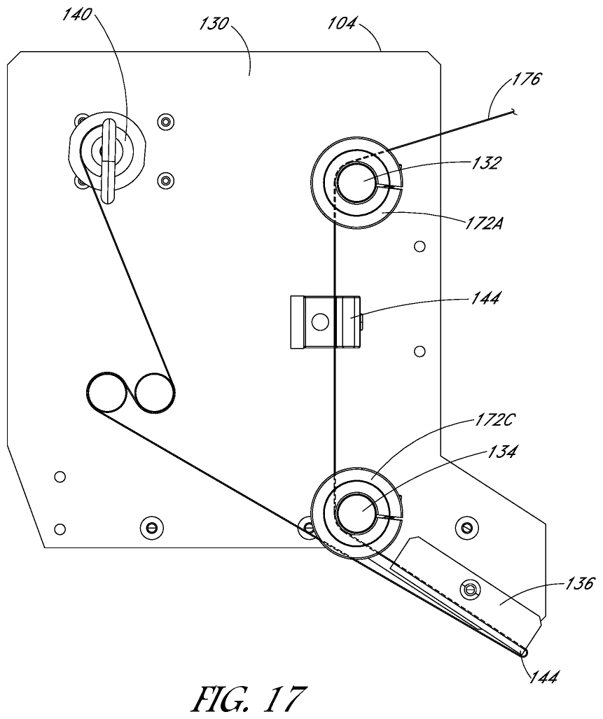

FIG. 6 illustrates a first side view of the labelling apparatus 100. FIG. 7 illustrates a second side view of the labelling apparatus 100. FIG. 8 illustrates a perspective view of the lower assembly 104. FIG. 9 illustrates top view of the lower assembly 104. FIG. 10 illustrates a cross-sectional view of the lower assembly 104 taken along line 10-10 as shown in FIG. 9. FIG. 11 illustrates a rear view of the lower assembly 104. FIG. 12 illustrates a front view of the lower assembly 104. FIG. 13 illustrates a cross-sectional view of the lower assembly 104 taken along lines 13-13 as shown in FIG. 12. FIG. 14 illustrates a side view of the lower assembly 104. FIG. 15 illustrates a second side view of the lower assembly 104.

FIG. 16 illustrates a perspective view of the upper assembly 102. As shown in FIG. 16, in certain embodiments, the sensor 144 can include a slot or gap 145 through which a roll or sheet of labels can pass.

As shown in FIG. 16, the spool 140 can include a shaft 168 coupled to a pin 170. In certain embodiments, the pin 170 can be configured to secure a portion of a backing of the roll or sheet of labels to the shaft 168. The pin 170 can secure the portion of the backing of the roll or sheet of labels to the shaft 168 so that rotation of the shaft 168 causes the backing to wind around the shaft 168.

As shown in FIG. 16, in certain embodiments, a bar 137 can extend across the plate 136. In certain embodiments the bar 137 can be configured to align the row or sheet of labels on the plate 136. In certain embodiments, the bar 137 can hold the tag in place and secure the label to the tag and then feed the labeled tag to the labeled tag tray 108.

FIG. 17 illustrates an example of a sheet or roll of labels 176 positioned within the upper assembly 102. FIG. 17A shows a cross-sectional view of the labelling apparatus 100 taken along line 5A-5A as shown in FIG. 5 showing the roll of labels 176 positioned within the upper assembly 102. FIG. 17A includes arrows showing movement of the roll of labels 176 within the upper assembly 102. FIG. 17B shows a sectional view of the labelling apparatus 100 taken along line 17B-17B as shown in FIG. 17A. FIG. 17B shows an enlarged view of the sheet or roll of labels 176 wrapped around the distal end 139 of the plate 136.

In certain embodiments, the labelling apparatus 100 can be configured to secure a plurality of labels to a plurality of tags simultaneously. As described herein, the tray 118 can be configured to house a plurality of tags positioned laterally adjacent to one another in a horizontal layer of tags. In certain embodiments, the plurality of tags in the horizontal layer of tags can be drawn by the rollers 156A-E through the lower assembly 104 to the intersection point simultaneously such that the plurality of tags will reach the intersection point at the same time. In certain embodiments, the roll or sheet of labels 176 can include a plurality of labels positioned laterally adjacent one another. In certain embodiments, the plurality of labels can reach the intersection point simultaneously and engage the multiple tags simultaneously. In certain embodiments, the labelling apparatus 100 can be configured two secure one, two, three, four, five, six, or any other suitable number of labels to a corresponding number of tags simultaneously.

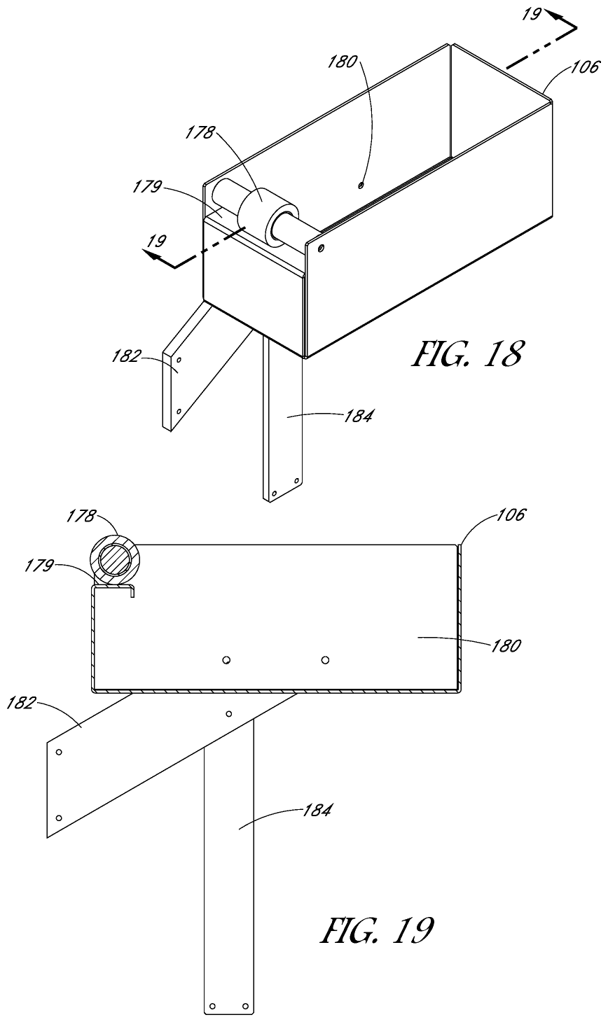

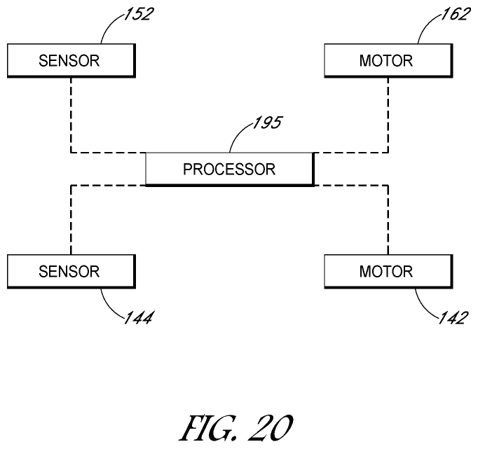

FIG. 18 shows a perspective view of the tray 106. The tray 106 can include an inner chamber 180 configured to house a plurality of labels, such as the roll or sheet of labels 176. In certain embodiments, the tray 106 can include a roller 178. In certain embodiments the tray 106 can include a surface 179. In certain embodiments, the roll or sheet of labels 176 can be drawn from the chamber 180 between the roller 178 and the surface 179. In certain embodiments, the roll or sheet of labels 176 can be drawn from between the roller 178 and the surface 179 to the upper assembly 102.

FIG. 20 shows block diagram of electronic components of the labelling apparatus 100. In certain embodiments, the labelling apparatus can include one or more processors 195. In certain embodiments, the one or more processors 195 can be coupled to one or more of the sensor 152, the sensor 144, the motor 162, and the motor 142.

In certain embodiments, the one or more processors 195 can be configured to receive sensor data from the sensor 144. In certain embodiments, the one or more processors 195 can be configured to determine the position of one or more labels on the roll or sheet of labels 176 based on the sensor data from the sensor 144. In certain embodiments, the one or more processors 195 can be configured to determine when the roll or sheet of labels is positioned within the upper assembly 102 such that a label is peeled at least partially away from the backing of the roll or sheet of labels 176 and positioned at the intersection point.

In certain embodiments, the one or more processors 195 are configured to control the motor 142. In certain embodiments, the one or more processors 195 are configured to control the speed of the motor 142. In certain embodiments, the one or more processors 195 are configured to control a start and stop of the motor 142.

In certain embodiments, the one or more processors 195 can be configured to receive sensor data from the sensor 152. In certain embodiments, the one or more processors 195 can be configured to determine the position of one or tags moving through the lower assembly 104 based on the sensor data from the sensor 144. In certain embodiments, the one or more processors 195 can be configured to determine when the one or more tags are positioned at the intersection point to receive the one or more labels.

In certain embodiments, the one or more processors 195 are configured to control the motor 162. In certain embodiments, the one or more processors 195 are configured to control the speed of the motor 162. In certain embodiments, the one or more processors 195 are configured to control a start and stop of the motor 162.

In certain embodiments, the one or more processors 195 are configured to control one or both of the motors 142 and 162 to align the tags with the labels at the intersection point. In certain embodiments, the one or more processors 195 are configured to control a speed and/or a start and stop of one or both of the motors 142 and 162 to align the tags with the labels at the intersection point. For example, in certain embodiments, the one or more processors 195 can be configured to stop the motor 142 when it is determined that the sheet or roll of labels 176 is positioned such that a label is peeled at least partially away from the backing of the roll or sheet of labels 176 and positioned at the intersection point. The motor 162 can remain active so that a tag moves distally along the lower assembly 104 to engage the peeled label and cause the peeled label to adhere to the tag. After the peeled label adheres to the tag, the motor 142 can be initiated to cause the roll or sheet of labels 176 to continue moving throughout the upper assembly 102. In certain embodiments, the one or more processors 195 can determine that a tag has engaged a label at the intersection point based on information from one or both of the sensors 152 and 162.

While the above detailed description has shown, described, and pointed out novel features of the development as applied to various embodiments, it will be understood that various omissions, substitutions, and changes in the form and details of the devices illustrated may be made by those skilled in the art without departing from the spirit of the development. As will be recognized, the present development may be embodied within a form that does not provide all of the features and benefits set forth herein, as some features may be used or practiced separately from others. All changes which come within the meaning and range of equivalency of the claims are to be embraced within their scope.

The foregoing description details certain embodiments of the systems, devices, and methods disclosed herein. It will be appreciated, however, that no matter how detailed the foregoing appears in text, the systems, devices, and methods may be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment may be included with other depicted embodiments in any combination. For example, any of the various components described herein and/or depicted in the Figures may be combined, interchanged or excluded from other embodiments.

With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The term “comprising” as used herein is synonymous with “including,” “containing,” or “characterized by,” and is inclusive or open-ended and does not exclude additional, unrecited elements or method steps.

The above description discloses several methods of manufacture and materials of the present development. This development is susceptible to modifications in the methods and materials, as well as alterations in the fabrication methods and equipment. Such modifications will become apparent to those skilled in the art from a consideration of this disclosure or practice of the development disclosed herein. Consequently, it is not intended that this development be limited to the specific embodiments disclosed herein, but that it cover all modifications and alternatives coming within the true scope and spirit of the development as embodied in the attached claims.

While the above detailed description has shown, described, and pointed out novel features of the improvements as applied to various embodiments, it will be understood that various omissions, substitutions, and changes in the form and details of the device or process illustrated may be made by those skilled in the art without departing from the spirit of the invention. As will be recognized, the present invention may be embodied within a form that does not provide all of the features and benefits set forth herein, as some features may be used or practiced separately from others. The scope of the invention is indicated by the appended claims rather than by the foregoing description. All changes which come within the meaning and range of equivalency of the claims are to be embraced within their scope.

What is claimed is:

1. A high-speed labelling apparatus, comprising:
a first tray configured to support a plurality of tags arranged in at least one stack;
a second tray disposed above the first tray and configured to support a sheet of a plurality of labels positioned on a backing;
a plurality of rollers configured to draw tags one at a time from a bottom of one stack of the at least one stack and transport the drawn tags to the intersection point, the intersection point having an edge;
a first motor configured to drive the plurality of rollers; and
a second motor configure to drive movement of the sheet to the intersection point and about the edge of the intersection point so as to cause one or more labels of the plurality of labels to peel from the backing at the intersection point;
wherein the first motor and the second motor are configured to control movement of the drawn tags and the sheet so that each of the drawn tags one at a time engages a label of the one or more labels peeled from the backing at the intersection point.

2. The high-speed labelling apparatus of claim 1, wherein the plurality of tags are arranged in two stacks, wherein the plurality of rollers are further configured to draw a pair of tags from the bottom of the two stacks simultaneously and transport the drawn pair of tags side-by-side to the intersection point, and wherein the first motor and the second motor are further configured to control movement of the drawn pair of tags and the sheet so that each tag of the pair of tags engages a label of the one or more labels peeled from the backing at the intersection point.

3. A labelling apparatus, comprising:
a first motor configured to drive movement of one or more tags of a plurality of tags from a first tray holding the plurality of tags to an intersection point; and
a second motor configure to drive movement of a sheet from a second tray to the intersection point and about an edge at the intersection point, the sheet comprising a plurality of labels positioned on a backing, wherein movement of the sheet about the edge causes one or more labels to peel from the backing at the intersection point;
wherein the first motor and the second motor are configured to drive movement of the one or more tags and the sheet so that the one or more tags engage the one or more labels peeled from the backing at the intersection point.

4. The labelling apparatus of claim 3, further comprising a plurality of rollers configured to draw the one or more tags from the first tray and transport the tags to the intersection point, wherein the plurality of rollers are coupled to the first motor.

5. The labelling apparatus of claim 3, further comprising a sensor positioned to detect the one or more tags as the one or more tags are transported from the first tray to the intersection point.

6. The labelling apparatus of claim 5, wherein the sensor is an optical sensor.

7. The labelling apparatus of claim 5, further comprising one or more processors configured to adjust operation of the first motor based at least in part on information from the sensor.

8. The labelling apparatus of claim 7, wherein the one or more processors are configured to adjust a speed of the first motor based at least in part on information from the sensor.

9. The labelling apparatus of claim 7, wherein the one or more processors are configured to activate and/or deactivate the first motor based at least in part on information from the sensor.

10. The labelling apparatus of claim 3, further comprising a spool configured to rotate to wind the sheet around the spool, wherein the spool is coupled to the second motor.

11. The labelling apparatus of claim 3, further comprising a sensor positioned to detect gaps between the one or more labels on the sheet as the one or more labels are transported from the second tray to the intersection point.

12. The labelling apparatus of claim 11, wherein the sensor is an optical sensor.

13. The labelling apparatus of claim 11, further comprising one or more processors configured to determine that a label is positioned at the intersection point and at least partially peeled from the backing based on information from the sensor.

14. The labelling apparatus of claim 13, wherein the one or more processors are configured to adjust the operation of the second motor based at least in part on information from the sensor.

15. A method for attaching a label of a plurality of labels to a tag of a plurality of tags, comprising:
controlling a first motor to drive a sheet comprising a backing and the plurality of labels towards an intersection point;
determining that the label is positioned at the intersection point based on information from a first sensor;
deactivating the first motor to stop movement of the label at the intersection point based on the determination that the label is positioned at the intersection; and
controlling a second motor to transport the tag to the intersection point to engage the label based on information from a second sensor.

16. The method of claim 15, wherein the first sensor is configured to detect gaps between the one or more labels on the sheet as the one or more labels are transported from to the intersection point.

17. The method of claim 16, wherein controlling the first motor to drive the sheet towards the intersection point comprises controlling a speed of the first motor based on information from the first sensor.

18. The method of claim 15, wherein the second sensor is configured to detect each tag of the plurality of tags as the plurality of tags are transported to the intersection point.

19. The method of claim 18, controlling the second motor to transport the tag to the intersection point to engage the label based on information from the second sensor comprises controlling a speed of the second motor based on information from the second sensor.

20. The method of claim 15, wherein the second motor is configured to control a plurality of rollers configured to draw the tags to the intersection point.
